(19) United States
(12) Patent Application Publication
(10) Pub. No.: US 2014/0020810 A1
(43) Pub. Date: Jan. 23, 2014

(54) CAPACITIVE TOUCH PANEL, MANUFACTURING METHOD THEREFOR AND LIQUID CRYSTAL DISPLAY APPARATUS PROVIDED WITH THE TOUCH PANEL

(71) Applicant: SUMITOMO METAL MINING CO., LTD., Tokyo (JP)

(72) Inventors: Tokuyuki Nakayama, Ichikawa-shi (JP); Yoshiyuki Abe, Ichikawa-shi (JP)

(21) Appl. No.: 13/938,889

(22) Filed: Jul. 10, 2013

Related U.S. Application Data
(62) Division of application No. 12/654,571, filed on Dec. 23, 2009.

(30) Foreign Application Priority Data
Dec. 26, 2008 (JP) 2008-334686
Nov. 12, 2009 (JP) 2009-258542

(51) Int. Cl. G06F 3/044

(52) U.S. Cl. CPC G06F 3/044
USPC 156/60

(57) ABSTRACT

A capacitive touch panel, which is capable of providing high quality display, without a problem of position detection, having a structure where at least a transparent conductive film and a dielectric layer are laminated onto a transparent substrate, and a member for position detection comprising at least a wiring portion for position detection along with a electrodes for position detection is arranged at said substrate frame portion, characterized in that the transparent conductive film is composed of an oxide having indium oxide as a main component and containing gallium and tin; and this is provided by a method for producing a capacitive touch panel, characterized in that after forming an amorphous transparent conductive film composed of an oxide having indium oxide as a main component and containing gallium and tin onto the transparent substrate or the like.

### BACKGROUND OF THE INVENTION

1. Field of the Invention

The present invention relates to a capacitive touch panel, a manufacturing method therefor, and a liquid crystal display apparatus provided with the touch panel, and in more detail, the present invention relates to a capacitive touch panel, which is capable of providing high quality display without a problem of position detection, even in the case where a production process with lower cost and higher heat load is adopted by application of a transparent conductive film with high heat resistance, a manufacturing method therefor, and a liquid crystal display apparatus.

2. Description of the Prior Art

A touch panel is one for carrying out an operation of an apparatus and a system by a method that an operator contacts with a transparent surface installed at the upper part of the display screen with a pen or a finger. Because operation by direct contact to a view screen is direct and intuitive, the touch panel has been adopted in many fields in recent years.

The touch panel is one for detecting position of a place contacted, and as the detection system, there are a resistive-type, a capacitive-type, an ultrasonic-type, an optical-type or the like. These detection systems use the different system depending on use environment, however, the resistive touch panel is widely used in view of cost, and in particular, the touch panel mounted onto various portable type devices such as a personal digital assistant (it may be referred to as PDA), a mobile phone, a video camera, a digital still camera is a resistive-type inmost cases (for example, refer to Patent Literature 1).

A configuration example of the resistive touch panel is shown in FIG. 1, in a mounted state onto the liquid crystal display apparatus main body. A resistive touch panel 10 is provided with an upper part transparent substrate 11, an upper part transparent conductive film 12 formed on a surface of the upper part transparent substrate 11, a lower part transparent substrate 14, and a lower part transparent conductive film 15 formed onto the surface of the lower part transparent substrate 14 and arranged facing to the upper part transparent conductive film 12. At the outer circumference part of the upper part transparent substrate 11 and the lower part transparent substrate 14, a pressure sensitive adhesive double coated tape 17 is adhered to specify distance between the upper part transparent conductive film 12 and the lower part transparent conductive film 15, and fix the upper part transparent substrate 11 and the lower part transparent substrate 14, and in this way an air layer 16 is formed. In addition, the liquid crystal display apparatus is configured by mounting the resistive touch panel 10 onto a liquid crystal display apparatus main body 50.

In this liquid crystal display apparatus, by pressing the upper part transparent substrate 11 with a tip part of a pen for data input or with a finger tip, input of data becomes possible, corresponding to view screen display of the liquid crystal display apparatus main body 50. That is, by pressing the upper part transparent substrate 11 with the tip part of the pen for data input etc., the upper part transparent substrate is deformed partially, and the upper part transparent conductive film 12 and the lower part transparent conductive film 15 are partially contacted. Resistance value of the upper part transparent conductive film 12 and the lower part transparent conductive film 15, corresponding to this contact, is detected, and based on resistance value detected, contact position is specified, and corresponding to data displayed on a view screen of the liquid crystal display apparatus main body 50 corresponding to this contact position, the data is input to a device incorporated with the liquid crystal display apparatus.

However, optical characteristics or durability of such a resistive touch panel is not necessarily sufficient for certain applications. That is, because the resistive touch panel has a configuration where an air layer is configured between two sheets of the transparent conductive films, there is a problem of decreasing optical characteristics (transmittance) by generation of light reflection at the interface thereof, caused by difference of refractive index of the transparent conductive film and the air layer. In addition, because of a configuration where pressing is repeated with the tip part of the pen for data input etc. to a laminated structure having the air layer at the intermediate region, there is also a problem of durability of the laminated structure.

On the other hand, the capacitive touch panel has been noticed, because of not only being a detection system avoidable of these problems but also capable of attaining low cost, and has been produced commercially in recent years (for example, refer to Non-Patent Literature 1, and Patent Literature 2).

The capacitive touch panel, different from a usual resistive-type, is configured so that by light touch at a view screen with a finger or an electro-conductive pen, electrostatic capacity is changed, and weak current is flown via a condenser thereof, and by detection of the change amount, position is calculated.

Voltages (AC) with the same phase and the same potential are applied to electrodes at the four corners of the capacitive touch panel. In this case, because the four electrodes are in the same potential, electric current does not flow between the electrodes (touch sensor parts). Then, an arbitrary point on the touch sensor parts is touched with the finger or the electro-conductive pen etc. In this action, by the Kirchhoff's law, the following relations are satisfied. It should be noted that resistance from the contact position to the electrodes A, D is represented by r1; resistance to the electrodes B, C is represented by r2; R is represented by R=r1+r2; and impedance from a contact substance to the ground in this case is represented by Z; and electric currents flowing the electrode, A, B, C and D is represented by ia, ib, ic and id, respectively.

(ia+id)r1+(ia+ib+ic+id)Z+V1=0 (1)

(ib+ic)r2+(ia+ib+ic+id)Z+V2=0 (2)

Here, by subtraction of (1) and (2), the next equation is given:

(ia+id)r1+V1=(ib+ic)r2+V2

Then, by substitution of R−r1=r2 for this equation, and by proper arrangement of the equation, the next equation (3) is obtained:

r1/R=(ib+ic)/(ia+ib+ic+id)+(V2−V1)/(ia+ib+ic+id)R (3)

In this circuit, usually there is no electric current flow from the electrodes A, B, C and D. Therefore, by assuming V1=V2 for setting no electric current flow, the equation (3) is converted to the next equation:

r1/R=(ib+ic)/(ia+ib+ic+id) (4)

When electric current flowing in each of the electrodes in the X axis direction and the Y axis direction, is determined by measurement, contact position can be determined by the above equation (4). Specifically, it is enough to attach the electric current detectors at the electrodes A, B, C and D, and to provide a signal processing circuit for calculating coordinate of the contact portion by an electric current signal from each of the electric current detectors. In addition, the equation (4) does not depend on the impedance between the contact substance and the ground. Therefore, change or state of the contact substance can be neglected, unless the impedance is zero or infinite, and thus the above equation is satisfied.

A configuration example of the capacitive touch panel is shown in FIG. 2. A capacitive touch panel 20 has a structure where a transparent conductive film 22 formed onto a transparent substrate 21, and a dielectric layer 23 are laminated sequentially. Here, as a transparent conductive film 22, generally an ITO crystal film is used in many cases. Here, because surface resistance of the transparent conductive film 22 is about 700Ω/□ to 2000Ω/□, it is possible to surely generate a signal for position detection, and surely transmit the signal for position detection to the circuit for position detection. In addition, at the frame portion of the relevant transparent conductive film 22, the wiring portion for position detection, and at each corner portion of the relevant transparent conductive film 22, the electrodes A, B, C and D for position detection are installed in an electrically connected state. By using the wiring portion for position detection and the electrodes for position detection 29 (hereafter may be called “the member for position detection”), and by a method for calculating the position coordinate of the contact portion by the above electric current signal, position can be detected.

In addition, the capacitive touch panel 20 configures the liquid crystal display apparatus by being mounted onto the liquid crystal display apparatus main body.

In such a configuration, it is necessary to surely generate a signal for position detection in the transparent conductive film 22, and surely transmit the signal for position detection to, for example, the circuit for position detection. In order to attain this, it is essential that surface resistance of the transparent conductive film 22 has the value in a specific range. In general, the ITO crystal film is used as the transparent conductive film, and surface resistance thereof is, as described above, 700 to 2000Ω/□ (this is read as “Ohm per square”), and preferably 1000 to 1500Ω/□.

Incidentally, in recent years, it has been required inevitably to select a production process giving severe load to a material to be used, in order to produce the capacitive touch panel in lower cost. For example, in the forming process of the wiring portion for position detection and the electrode for position detection etc. composed of an Ag or Ag alloy etc. in the production process of the touch panel display apparatus, there may be the case requiring to carry out the heat treatment at a high temperature of about 500° C. in air.

However, in the case where treatment is carried out under such high load in air, the transparent conductive film is oxidized, and a new problem is raised that surface resistance in the above range of 700 to 2000Ω/□ cannot be maintained, thus leading to increase in resistance. This increase in surface resistance of the transparent conductive film is not capable of transmitting the signal for position detection surely to the circuit for position detection, and was thus seen as a problem.

### [Patent Literature]

Patent Literature 1: JP-A-2003-307723
Patent Literature 2: JP-A-2008-32756

### [Non-Patent Literature]

Non-Patent Literature 1: Saburo Miyamoto et al., “Development of a high transmittance touch panel by an electrostatic capacity connection system”, Technical Report of Sharp Corp., No. 92, August, 2005, pp. 59 to 63.

### SUMMARY OF THE INVENTION

In view of such problems of conventional technology, it is an object of the present invention to provide a capacitive touch panel, which is capable of providing high quality display without a problem of position detection even in the case where a production process with lower cost and higher heat load is adopted by application of a transparent conductive film with high heat resistance, a manufacturing method therefor, and a liquid crystal display apparatus.

The present inventors have intensively studied a way to produce the capacitive touch panel in lower cost, and found that by using the transparent conductive film composed of an oxide having indium oxide as a main component and containing gallium and tin, as the transparent conductive film of the capacitive touch panel having a structure where at least the transparent conductive film and a dielectric layer are laminated onto a transparent substrate, and a member for position detection comprising at least a wiring portion for position detection along with a electrodes for position detection is arranged at said substrate frame portion, there is provided little oxidation, and surface resistance in the above range of 700 to 2000Ω/□ can be maintained, thus leading to no increase in resistance, even by using a production process giving severe load to a material to be used, and in this way, the above problems can be solved, and have thus completed the present invention.

That is, according to a first aspect of the present invention, there is provided a capacitive touch panel having a structure where at least a transparent conductive film and a dielectric layer are laminated onto a transparent substrate, and a member for position detection comprising at least a wiring portion for position detection along with an electrode for position detection is arranged at said substrate frame portion, characterized in that the transparent conductive film is composed of an oxide having indium oxide as a main component and containing gallium and tin.

In addition, according to a second aspect of the present invention, there is provided the capacitive touch panel in the first aspect, characterized in that gallium content of the transparent conductive film is 0.03 to 0.10 as atomic ratio of Ga/(In+Ga+Sn), and tin content is 0.05 to 0.12 as atomic ratio of Sn/(In+Ga+Sn).

In addition, according to a third aspect of the present invention, there is provided the capacitive touch panel in the first or second aspect, characterized in that gallium content of the transparent conductive film is 0.05 to 0.08 as atomic ratio of Ga/(In+Ga+Sn), and tin content is 0.07 to 0.10 as atomic ratio of Sn/(In+Ga+Sn).

In addition, according to a fourth aspect of the present invention, there is provided the capacitive touch panel in the first aspect, characterized in that surface resistance of the transparent conductive film is 700 to 2000 Ω/□.

In addition, according to a fifth aspect of the present invention, there is provided a method for producing a capacitive touch panel having a structure where at least a transparent conductive film and a dielectric layer are laminated onto a transparent substrate, and a member for position detection comprising at least a wiring portion for position detection along with an electrode for position detection is arranged at said substrate frame portion, characterized in that after forming an amorphous transparent conductive film composed of an oxide having indium oxide as a main component and containing gallium and tin onto the transparent substrate, and before forming process of the member for position detection, the transparent conductive film is subjected to heat treatment in a temperature range with crystallization temperature, as the lower limit, and with temperature higher by 100° C. than the crystallization temperature, as the upper limit, under atmosphere where oxygen is present, or in air.

In addition, according to a sixth aspect of the present invention, there is provided the method for producing the capacitive touch panel in the fifth aspect, characterized in that the amorphous transparent conductive film is formed onto the transparent substrate at a temperature of equal to or lower than 150° C.

In addition, according to a seventh aspect of the present invention, there is provided the method for producing a capacitive touch panel having a structure where at least a transparent conductive film and a dielectric layer are laminated onto a transparent substrate, and a member for position detection comprising at least a wiring portion for position detection along with an electrode for position detection is arranged at said substrate frame portion, characterized in that, the above amorphous or crystalline transparent conductive film is subjected to heat treatment in a temperature range with crystallization temperature, as the lower limit, and with a temperature of 550° C., as the upper limit, under atmosphere where oxygen is present, or in air, in the forming process of the member for position detection.

In addition, according to an eighth aspect of the present invention, there is provided the method for producing the capacitive touch panel in the fifth or seventh aspect, characterized in that gallium content of the transparent conductive film is 0.03 to 0.10 as atomic ratio of Ga/(In+Ga+Sn), and tin content is 0.05 to 0.12 as atomic ratio of Sn/(In+Ga+Sn).

In addition, according to a ninth aspect of the present invention, there is provided the method for producing the capacitive touch panel in the fifth or seventh aspect, characterized in that gallium content of the transparent conductive film is 0.05 to 0.08 as atomic ratio of Ga/(In+Ga+Sn), and tin content is 0.07 to 0.10 as atomic ratio of Sn/(In+Ga+Sn).

In addition, according to a tenth aspect of the present invention, there is provided a liquid crystal display apparatus mounted with the capacitive touch panel in any of the first to fourth aspects, so that the dielectric layer is positioned at the outer surface on a view screen of the liquid crystal display apparatus main body.

Because the capacitive touch panel of the present invention adopted the capacitive touch panel having a structure where at least the transparent conductive film and the dielectric layer are laminated onto the transparent substrate, and a member for position detection comprising at least a wiring portion for position detection along with a electrodes for position detection is arranged at said substrate frame portion, and as the transparent conductive film composed of an oxide having indium oxide as a main component and containing gallium and tin, the transparent conductive film has high heat resistance, and thus a capacitive touch panel, which is capable of providing high quality display without a problem of position detection even in the case where a production process with lower cost and higher heat load is adopted, a manufacturing method therefor, and a liquid crystal display apparatus can be obtained.

In addition, because in the capacitive touch panel, after forming an amorphous transparent conductive film composed of an oxide having indium oxide as a main component and containing gallium and tin onto the transparent substrate, the transparent conductive film is subjected to heat treatment in a specific temperature range under atmosphere where oxygen is present, resistance of the transparent conductive film does not increase, and thus there is no problem raised on position detection of the capacitive touch panel, and display of the liquid crystal display apparatus main body.

In this way, the low cost production process can be adopted, and also the capacitive touch panel and the liquid crystal display apparatus having good performance enabling high quality display, can be provided.

### BRIEF DESCRIPTION OF THE DRAWINGS

FIG. 1 is an explanation drawing showing the cross-section of a liquid crystal display apparatus mounting a conventional resistive touch panel.

FIG. 2 is an explanation drawing showing the cross-section of a conventional capacitive touch panel.

FIG. 3 is an explanation drawing showing the cross-section of the capacitive touch panel of the present invention.

FIG. 4 is an explanation drawing showing the cross-section of the liquid crystal display apparatus of the present invention.

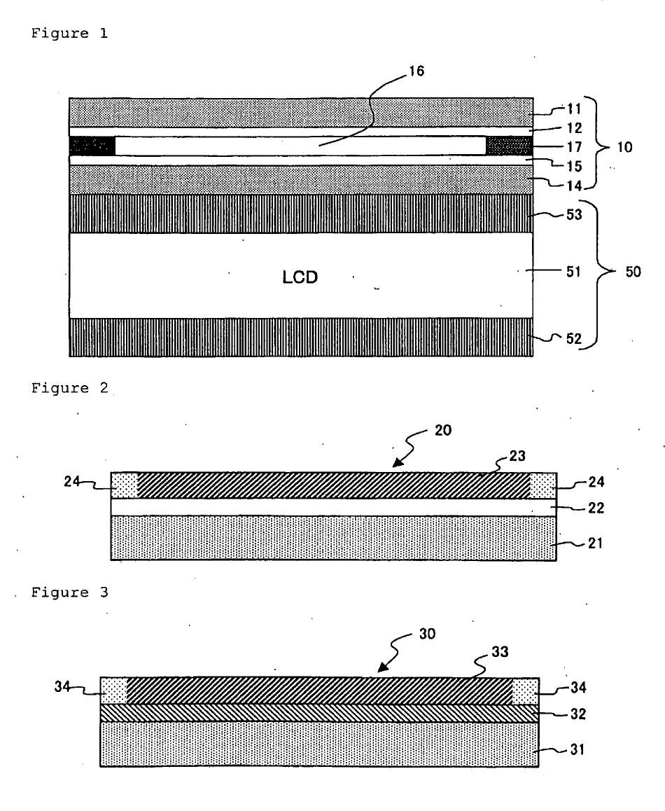

### NOTATION

10: Resistive touch panel
11, 14, 21, 31: Transparent substrate
12, 15: Transparent conductive film
16: Air layer
17: Pressure sensitive adhesive double coated tape
20: Capacitive touch panel (conventional one)
22: Transparent conductive film (ITO crystal film)
23, 33: Dielectric layer
24, 34: Wiring portion for position detection and electrodes for position detection (member for position detection)
30: Capacitive touch panel (the present invention)
32: Transparent conductive film (an oxide having indium oxide as a main component and containing gallium and tin)
50: Liquid crystal display apparatus main body
51: Liquid crystal
52, 53: Polarization plate

### DETAILED DESCRIPTION OF THE INVENTION

Explanation will be given below in detail on the capacitive touch panel of the present invention, and a manufacturing method therefor.

### 1. The Capacitive Touch Panel

The capacitive touch panel of the present invention is the capacitive touch panel having a structure where at least a transparent conductive film and a dielectric layer are laminated onto a transparent substrate, and a member for position detection comprising at least a wiring portion for position detection along with a electrodes for position detection is arranged at said substrate frame portion, characterized in that the transparent conductive film is composed of an oxide having indium oxide as a main component and containing gallium and tin.

The capacitive touch panel of the present invention has a structure where the cross-section is shown by FIG. 3. As shown in FIG. 3, a capacitive touch panel 30 has a structure where a transparent conductive film 32 formed onto a transparent substrate 31, and a dielectric layer 33 are laminated sequentially. Here, the dielectric layer 33 includes also the case of being a black matrix and a color filter layer, depending on an apparatus configuration, other than a film composed of silicon oxide in the above general touch panel display apparatus.

In addition, the capacitive touch panel of the present invention, in addition to a structure where the transparent conductive film 32 and the dielectric layer 33 are laminated sequentially, includes the case where the transparent conductive film is formed, which is composed of the wiring portion for position detection and the electrode for position detection 34 composed of an Ag or Ag alloy at the substrate frame portion. Still more it includes the case where the transparent conductive film is formed, which is composed of the black matrix, the color filter layer and an ITO film etc., where a signal for display is supplied, so as to configure a touch panel.

Here, the transparent substrate 31 may be a glass substrate etc., having electric insulation property and high light transmittance of a visible light region, and being endurable to heat treatment temperature, for example 500° C., in heating treatment (hereafter may be called “heating treatment process”) in the forming process of the wiring portion for position detection and the electrode for position detection etc., composed of an Ag or Ag alloy etc. in the production process of the touch panel display apparatus.

Thickness of the substrate is not especially limited, however, in the case of a glass plate or a quartz plate, it is set from 0.1 to 10 mm, and preferably from 0.5 to 5 mm. The thickness thinner than this range decreases strength, and makes handling difficult. On the other hand, the thickness thicker than this range not only deteriorates transparency bur also increases weight, and thus it is not preferable. It should be noted that because a glass substrate containing an alkali component, such as soda lime glass, has risk to impair characteristics thereof, caused by diffusion of the alkali component into the transparent conductive film formed onto the substrate, it is preferable to adopt a structure inserted with a silicon oxide thin film etc. as a barrier layer between the glass substrate and the transparent conductive film.

It is preferable that the above transparent conductive film to be used in the capacitive touch panel of the present invention is composed of an oxide having indium oxide, as a main component, wherein gallium content is 0.03 to 0.10 as atomic ratio of Ga/(In+Ga+Sn), and tin content is 0.05 to 0.12 as atomic ratio of Sn/(In+Ga+Sn). Still more, it is more preferable that gallium content of the transparent conductive film is 0.05 to 0.08 as atomic ratio of Ga/(In+Ga+Sn), and tin content is 0.07 to 0.10 as atomic ratio of Sn/(In+Ga+Sn). The transparent conductive film having a composition within the above range shows not only high heat resistance but also a high crystallization temperature of equal to or higher than 250° C., higher than crystallization temperature of ITO, which is about 190° C.

On the other hand, the gallium content of below 0.03, as atomicity ratio of Ga/(In+Ga+Sn), makes crystallization temperature below 250° C., and thus it is not preferable. On the other hand, the gallium content of over 0.10 increases resistivity of the transparent conductive film, by which film thickness required to obtain surface resistance, which is said necessary in the capacitive touch panel, becomes thick, and raises a problem of impairing high visibility, which is originally superior as compared with the resistive touch panel, and thus it is not preferable. In addition, the tin content of below 0.05, as atomicity ratio of Sn/(In+Ga+Sn), does not provide sufficient doping effect of tin to be described later, in the crystallization process of the transparent conductive film, in the heating treatment process, and thus it is not preferable, and the content of over 0.12 rather inhibits doping effect by excess tin, and thus it is not preferable.

The dielectric layer 33 is an optical thin film composed of a dielectric body, and kind and thickness thereof may be determined, corresponding to a sensing level of a circuit to be formed in the capacitive touch panel 30. For example, it is preferable to form a silicon oxide thin film with a thickness of 50 to 100 nm, by a sputtering method etc. onto the transparent conductive film 32.

It should be noted that an antireflection film (it may be described as an AR film) may be formed onto the dielectric layer 33. As the antireflection film, one laminated with two or more refractive index layers having different refractive index, may be used, for example, one with a four-layer-structure composed of a first refractive index layer, a second refractive index layer, a third refractive index layer, and a fourth refractive index layer; or a three-layer-structure composed of the first to the third refractive index layers. Here, in the case of adopting a multi-layer structure, as has been known conventionally, by designing difference of refractive index between adjacent refractive index layers, or by adjusting optical thickness of the refractive index layers to about ¼ of light wavelength λ (in particular, wavelength of 550 nm of wavelength having highest visibility), antireflection performance in a whole visible light region can be obtained by utilization of optical interference effect.

A material of the refractive index layer with relatively high refractive index, among the refractive index layers configuring the antireflection film, is not especially limited, as long as an optically transparent material has a refractive index of equal to or higher than 1.85, however, silicon nitride, titanium oxide, niobium oxide, tantalum oxide, ITO, and an alloy oxide having these as main components, and added with a metal such as silicon, tin, zirconium, aluminum, within a range not to give influence on characteristics thereof, is generally used. On the other hand, as the refractive index layer having relatively low refractive index, a material such as magnesium fluoride, silicon oxide etc. or a material mixed with trace amount of additive thereto is used, however, SiO₂ is most desirable in the case of using a sputtering method.

In addition, when antistatic performance is required, the above transparent conductive film composed of an oxide having indium oxide as a main component and containing gallium and tin, may be used, and an conductive film such as general ITO may also be used.

In addition to this, onto the dielectric layer 33, a protection film layer, an antifouling layer or an antiglare film layer or the like may be formed, if necessary. In addition, by installment of a second transparent substrate onto the top surface and by roughening of the surface thereof, the protection film layer or the antiglare film layer becomes unnecessary.

Incidentally, a display apparatus using a general capacitive touch panel has been prepared via the following processes:

(1) First, onto a glass substrate, a transparent conductive film (a thickness of about 5 to 15 nm) composed of a crystalline or amorphous ITO film or IZO (Indium Zinc Oxide) film is formed by a sputtering method using a mask, so that surface resistance becomes desired resistance value, to form a transparent electrode (hereafter may also be referred to as a first transparent electrode). It is possible to surely generate a signal for position detection in the transparent electrode, and surely transmit the signal for position detection to the circuit for position detection.
(2) Then, along the circumference end of the above transparent electrode, the transparent conductive film (a thickness of about 300 nm) composed of an ITO film etc. is formed, so that surface resistance becomes 3 to 5Ω, by a sputtering method using a mask, to form a frame portion.
(3) Then, onto the substrate formed with the transparent electrode and the frame portion, for example, an Al or Al alloy film (a thickness of about 300 nm) is formed, so that surface resistance becomes about 0.2 to 0.3Ω, by a sputtering method using a mask, to form the wiring portion for position detection and the electrodes for position detection A, B, C and D. This process is generally carried out at equal to or lower than 300° C., most often carried out at room temperature. Hereafter processes (1) to (3) may be referred to as the formation process of member for position detection.
(4) After that, onto the whole substrate formed with the wiring portion for position detection and the electrodes for position detection A, B, C and D, a photosensitive resist material etc. containing a black pigment is applied with a thickness of about 1 to 2 μm using a printing method, and then a pattern is formed to form a black matrix.
(5) Then, after applying the photosensitive resist material etc. dispersed with any of a red, green and blue pigment, with a thickness of about 1 to 3 μm, onto the whole substrate formed with the black matrix, a pattern is formed to form a color filter layer.
(6) Then, by film-formation of the transparent conductive film (a thickness of about 10 nm) composed of an ITO film etc. onto the whole substrate formed with the color filter layer, so that surface resistance becomes about 30 to 100Ω, by a sputtering method using a mask, the second transparent electrode is formed.

In a general case where the second transparent electrode, where a signal for display is supplied, is formed by a polycrystalline ITO film, because an amorphous ITO film or IZO film is used as the first transparent electrode for detecting touch position, and because it has higher electric resistance than that of the polycrystalline ITO film, it provides higher electric resistance than that of the second transparent electrode.

(7) After that, a polyimide resin etc. is applied onto the whole substrate formed with a pixel electrode, and it is subjected to alignment processing, to form a liquid crystal alignment film.
(8) Onto one of the touch panel and an active matrix substrate obtained as above, a sealing material composed of a thermosetting epoxy resin or the like is applied to a frame-like pattern deficient in a liquid crystal inlet part by screen printing, and onto the other substrate, a sphere-like spacer composed of a resin or silica, having diameter equivalent to thickness of a liquid crystal layer, is sprayed. After that, by adhering the active matrix substrate and the touch panel, the seal material is cured to form a vacant cell.
(9) Then, a liquid crystalline material is charged between the active matrix substrate and the touch panel of the vacant cell by a reduced pressure method to form a liquid crystal layer. After that, a UV curing resin is applied to the liquid crystal inlet, and the UV curing resin is cured by UV irradiation, to seal the inlet to prepare the capacitive touch panel.

In general, the capacitive touch panel is said to have higher cost as compared with the resistive touch panel. One of the factors causing cost increase is the film-formation process using a mask in vacuum, in the above formation process of member for position detection. In order to solve this, it is effective to adopt a process under atmosphere where oxygen is present, in particular, in air, instead of the film-formation process in vacuum. Specifically, among the above formation processes of member for position detection (1) to (3), a process, for example, (3), in vacuum for forming Al or an Al alloy thin film (a thickness of about 300 nm) by a sputtering method using a mask, so that surface resistance becomes about 0.2 to 0.3Ω, can be substituted by a process in air, using a paste agent composed of Ag or an Ag alloy. The paste agent composed of Ag or an Ag alloy is formed to the wiring portion for position detection and the electrodes for position detection, by being fired in air after being formed to predetermined shape.

### 2. A Method for Producing the Capacitive Touch Panel

A method for producing the capacitive touch panel of the present invention is a method for producing a capacitive touch panel having a structure where at least a transparent conductive film and a dielectric layer are laminated onto a transparent substrate, and a member for position detection comprising at least a wiring portion for position detection along with a electrodes for position detection is arranged at said substrate frame portion, characterized in that after forming an amorphous transparent conductive film composed of an oxide having indium oxide as a main component and containing gallium and tin, onto the transparent substrate, the transparent conductive film is subjected to heat treatment in a temperature range with crystallization temperature, as the lower limit, and with temperature higher by 100° C. than the crystallization temperature, as the upper limit, under atmosphere where oxygen is present, or in air (hereafter may be referred to as the first production method). Alternatively, it is characterized in that the above amorphous or crystalline transparent conductive film is subjected to heat treatment in a temperature range with a crystallization temperature, as the lower limit, and with a temperature of 550° C., as the upper limit, under atmosphere where oxygen is present, or in air, in the forming process of the member for position detection (hereafter may be referred to as the second production method).

The present invention is one improved by applying the transparent conductive film composed of an oxide having indium oxide as a main component and containing gallium and tin, as the first transparent electrode formed onto the transparent substrate, in the preparation process of the above general touch panel display apparatus.

The transparent conductive film 32 is formed onto the transparent substrate 31 by a sputtering method etc. As the sputtering target, one with the same composition as that of the transparent conductive film can be used. That is, one having the gallium content of 0.03 to 0.10, as atomicity ratio of Ga/(In+Ga+Sn), and the tin content of 0.05 to 0.12, as atomicity ratio of Sn/(In+Ga+Sn), is preferable. As such a target, one described in PCT/JP2008/61957 by the present applicant, is included.

The case of forming the film onto the substrate by the sputtering method, in particular, the case of direct current (DC) sputtering method is industrially advantageous, because there is small thermal influence in film-formation, and high speed film-formation is possible. In order to form the film by the direct current sputtering method, it is preferable to use inert gas and oxygen, in particular, mixed gas composed of argon and oxygen. In addition, it is preferable to carry out sputtering by setting pressure inside a chamber of a sputtering apparatus at 0.1 to 1 Pa, particularly 0.2 to 0.8 Pa.

In the present invention, after evacuating down to, for example, equal to or lower than 2×10⁻⁴ Pa, mixed gas composed of argon and oxygen is introduced to increase gas pressure up to 0.2 to 0.5 Pa, and DC power is applied, so that direct current power per target area, that is direct current power density, is in a range of about 1 to 3 W/cm², to generate direct current plasma so as to carry out pre-sputtering. It is preferable to carry out sputtering by correcting substrate position, if necessary, after carrying out this pre-sputtering for 5 to 30 minutes.

It is desirable that a complete amorphous film is formed without generation of micro crystal in a film, even in the case where high thermal load is applied by high output power to enhance film-formation rate. It is preferable that the transparent conductive film 32 is formed by a sputtering method, however, it may be formed by an ion plating method or a vapor deposition method etc. It should be noted that by using a sputtering target prepared by an oxide sintered body described in the patent application described above (PCT/JP2008/61957) by the present applicant, the transparent conductive film with superior optical characteristics and electric conductivity can be produced onto the substrate in relatively high film-formation rate, by the direct current sputtering method.

In the present invention, film-formation can be carried out at room temperature without heating the substrate, however, it is possible to heat the substrate at 50 to 300° C. However, it is preferable that substrate temperature in film-formation is set at equal to or lower than crystallization temperature of the transparent conductive film, and more preferably equal to or lower than 150° C. Film-formation by increasing substrate temperature higher than crystallization temperature provides crystallization of the transparent conductive film, before heat treatment performed under atmosphere, where oxygen is present, after formation of the transparent conductive film, in the production process of the touch panel display apparatus; or before the heating treatment process of the forming process of the member for position detection for firing a paste agent composed of Ag or an Ag alloy under atmosphere, where oxygen is present, therefore only oxidation of the transparent conductive film is promoted and resistance increase is generated, by thermal load in the above heat treatment or heating treatment process under the atmosphere in the presence of oxygen, and thus it is not preferable.

When the transparent conductive film is an amorphous film, a carrier electron is generated and resistance decreases by doping effect of tin, in generation of crystallization caused by thermal load in the heating treatment process, under the atmosphere in the presence of oxygen. By offset between this resistance decrease and resistance increase by the above oxidation, resistance change can be made small apparently.

It is preferable that the amorphous transparent conductive film formed is crystallized by thermal load in the heating treatment process under the atmosphere in the presence of oxygen, however, the amorphous transparent conductive film formed may be crystallized by heat treatment under the atmosphere in the presence of oxygen, before the heat treatment process. In this way, the above resistance decrease by tin and resistance increase by oxidation can be progressed in certain degree, before adding thermal load by heat treatment in the production process of the touch panel display apparatus.

As for temperature range of the heat treatment, it may be enough that crystallization temperature of the amorphous transparent conductive film is set as the lower limit, however, it is more preferable that temperature higher by 100° C. than the crystallization temperature is set as the upper limit by the first production method. Setting of the heat treatment temperature at lower than crystallization temperature of the amorphous transparent conductive film does not provide effect of decreasing resistance owing to generation of the carrier electron by doping effect of tin, and thus not preferable. In addition, setting of the heat treatment temperature over temperature, higher by 100° C. than the crystallization temperature of the amorphous transparent conductive film, leads to repeated fierce oxidation including the heating treatment process, and thus not preferable. It should be noted that reason for setting the upper limit at temperature, higher by 100° C. than the crystallization temperature, is because this temperature range generates the carrier electron by doping effect of tin, and provides sufficient effect of decreasing resistance.

Atmosphere of the heat treatment is preferably atmosphere where oxygen is present, and air atmosphere is convenient and good. It is because by offset between the above resistance decreases owing to tin and resistance increase by oxidation, resistance change can be made small apparently.

Temperature increasing rate is not especially limited, however, it is preferable to set at equal to or higher than 1° C./min. It is because exposure to atmosphere where oxygen is present at lower temperature than crystallization temperature, for a long period of time, excessively promotes resistance increase by oxidation.

Thickness of the amorphous transparent conductive film formed and the transparent conductive film after crystallization by heat treatment of the amorphous transparent conductive film is not especially limited, and 5 to 20 nm is enough. Preferably, the thickness is 8 to 15 nm. The case where the thickness is below 5 nm does not provide sufficiently low surface resistance as the transparent conductive film, while the thickness over 20 nm cannot maintain high optical transmittance as the transparent conductive film.

In the present invention, surface resistance of the transparent conductive film is enough to be in a range of 700 to 2000Ω/□, and more preferably 1000 to 1500Ω/□. In the case where the surface resistance is higher value or lower value than this range, as described above, the signal for position detection cannot be transmitted surely to a circuit.

The transparent conductive film 32 is required to have high heat resistance, and in order to attain this, it must be an oxide having indium oxide as a main component and containing gallium and tin. It is preferable that composition thereof is indium oxide as a main component, and gallium content of the transparent conductive film is 0.03 to 0.10 as atomic ratio of Ga/(In+Ga+Sn), and tin content is 0.05 to 0.12 as atomic ratio of Sn/(In+Ga+Sn). In addition, it is more preferable that composition thereof is indium oxide as a main component, and gallium content of the transparent conductive film is 0.05 to 0.08 as atomic ratio of Ga/(In+Ga+Sn), and tin content is 0.07 to 0.10 as atomic ratio of Sn/(In+Ga+Sn). The transparent conductive film with composition of the above range shows not only high heat resistance but also a high crystallization temperature of equal to or higher than 250° C., higher than crystallization temperature of ITO, which is about 190° C.

On the transparent conductive film 32, the dielectric layer 33 is formed. The dielectric layer is an optical thin film composed of a dielectrics body, and kind and thickness thereof may be determined, corresponding to a sensing level of a circuit to be formed in the capacitive touch panel 30. For example, it is preferable to form a silicon oxide thin film with a thickness of 50 to 100 nm by a sputtering method or the like onto the transparent conductive film 32.

The second production method is characterized in that, in the production method for the above capacitive touch panel, the above amorphous or crystalline transparent conductive film, obtained by heat treatment under atmosphere, where oxygen is present, after formation, is subjected to heat treatment in a temperature range with a crystallization temperature, as the lower limit, and with a temperature of 550° C., as the upper limit, under atmosphere where oxygen is present, or in air.

As for a temperature range of said heat treatment, the heat treatment temperature lower than crystallization temperature of the transparent conductive film does not provide effect that a carrier electron is generated and resistance decreases by doping effect of tin, and thus it is not preferable. In addition, when the heat treatment temperature is set at a high temperature of over 550° C., as a result of extremely fierce oxidation of the transparent conductive film, resistance increases in a higher degree than resistance decreasing effect by the above doping effect of tin, and thus it is not preferable. It should be noted that this temperature range is same also in the case where the transparent conductive film is amorphous or a crystalline state obtained after heat treatment under atmosphere, where oxygen is present, after formation.

### 3. The Liquid Crystal Display Apparatus.

The liquid crystal display apparatus of the present invention is one where the capacitive touch panel is mounted, so that the dielectric layer is positioned at the outer surface on a view screen of the liquid crystal display apparatus main body.

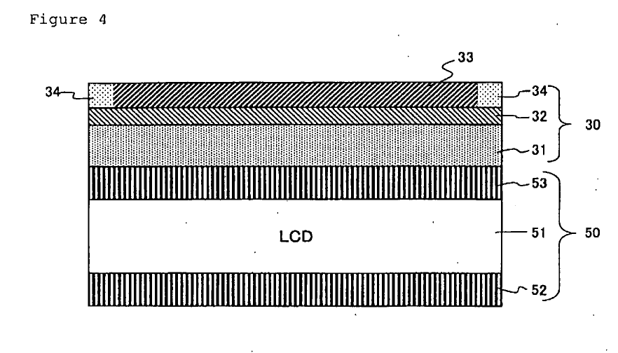

Then, a combination example of the capacitive touch panel 30 and the liquid crystal display apparatus main body 50 is shown in FIG. 4. It is a configuration where the capacitive touch panel 30 is mounted onto the view screen of the liquid crystal display apparatus main body 50 equipped with the liquid crystal 51, composed of an liquid crystal alignment film and switching elements for pixel electrodes driving liquid crystal, and polarizing plates 52 and 53, so that a dielectric layer 33 is present at the outer surface.

The liquid crystal display apparatus main body 50 drives the switching element for liquid crystal drive by a drive circuit (not shown), when power source is switched on, changes an arrangement state of the liquid crystal, and displays characters or picture images.

In this case, voltages are also applied to the electrodes at the four corners of the thin-type capacitive touch panel 30, and when corresponding part on the dielectric layer 33, where items to be selected from, for example, characters or picture images displayed on the view screen of the liquid crystal display apparatus main body 50, is positioned, is touched with a finger etc., electrostatic capacity changes by capacity connection of the contact parts, and thus position coordinate is calculated by the above equation (4), as described above. Then, the signal showing the position coordinate is output to a control circuit, and the control circuit is possible to specify touch position, corresponding to characters or picture images displayed on the view screen of the liquid crystal display apparatus main body 50, based on the coordinate signal. Therefore, the control circuit is possible to display characters or picture images on the view screen of the liquid crystal display apparatus main body 50, based on content corresponding to touch position, or to order other apparatuses to carry out corresponding processing.

It should be noted that as the liquid crystal display apparatus main body 50, TFT liquid crystal, where the liquid crystal drive switching element is TFT, is suitable in view of light weight and low power consumption, however, also liquid crystal of other systems such as STN liquid crystal and the like may be used.

In addition, the present invention is, as described above, the capacitive touch panel having a structure where at least a transparent conductive film and a dielectric layer are laminated onto a transparent substrate, and the transparent conductive film is one composed of an oxide having indium oxide as a main component and containing gallium and tin, and such a transparent conductive film may be applicable effectively not only to the capacitive touch panel but also to the resistive touch panel.

### EXAMPLES

Explanation will be given below in detail on the present invention, with reference to Examples, however, the present invention should not be limited to these Examples.

### Example 1

The capacitive touch panel of the present invention having a configuration of FIG. 3 was prepared. As a transparent substrate, a soda lime glass substrate of 0.5 mm thickness (hereafter an SLG substrate) formed with a silicon oxide thin film was prepared, and a target composed of an oxide having indium oxide, as a main component, where gallium content is 0.05 as atomic ratio of Ga/(In+Ga+Sn), and tin content is 0.09 as atomic ratio of Sn/(In+Ga+Sn), was installed at a direct current magnetron sputtering apparatus (manufactured by ANELVA Corp.), equipped with a direct current power source not having arcing suppression function.

After that, by arranging the substrate just above the sputtering target, that is, at standing-still facing position, evacuating the sputtering apparatus at room temperature without heating and applying a direct current power of 200 W, direct current plasma was generated and sputtering was carried out to deposit the transparent conductive film onto the SLG substrate. The transparent conductive film was composed of an oxide having indium oxide, as a main component, where gallium content is 0.05 as atomic ratio of Ga/(In+Ga+Sn), and tin content is 0.09 as atomic ratio of Sn/(In+Ga+Sn). It was confirmed that generation phase of the film was amorphous, as an investigation result with X-ray diffraction measurement. Film thickness of this transparent conductive film was 12 nm, and surface resistance was about 1000Ω/□. Subsequently, an antireflection film composed of a silicon oxide thin film and a niobium oxide thin film was formed.

When a thermal load of 500° C. in air was applied in the formation process of member for position detection of the capacitive touch panel, surface resistance of the above transparent conductive film increased from 1000Ω/□ to 1300Ω/□, however, it never exceeded 1500Ω/□. Because increase in surface resistance was not so large, the signal for position detection of the capacitive touch panel was surely transmitted to the circuit for position detection, and in assembling the liquid crystal display apparatus main body, as shown in FIG. 4, there was no problem in display thereof. It should be noted that investigation of the above transparent conductive film, by disassembly of the assembled capacitive touch panel, revealed crystallization caused by application of thermal load.

### Example 2

The capacitive touch panel having a configuration of FIG. 3 was prepared by the similar process as in Example 1, except that target composition was changed to have indium oxide, as a main component, where gallium content is 0.10 as atomic ratio of Ga/(In+Ga+Sn). It was confirmed that the transparent conductive film had the same composition as the target, and generation phase of the film was amorphous, as an investigation result with X-ray diffraction measurement. Film thickness of this transparent conductive film was 15 nm, and surface resistance was 1000Ω/□.

When a thermal load of 500° C. in air was applied in the in the formation process of member for position detection of the capacitive touch panel, surface resistance of the above transparent conductive film increased from 1000Ω/□ to 1500Ω/□, however, it never exceeded 1500Ω/□, therefore there was no problem in the position detection of the capacitive touch panel, and the display of the liquid crystal display apparatus main body.

### Example 3

The transparent conductive film was formed onto the soda lime glass substrate (SLG substrate) formed with the silicon oxide thin film, similarly as in Example 1. The transparent conductive film was an amorphous transparent conductive film composed of an oxide having indium oxide, as a main component, where gallium content is 0.05 as atomic ratio of Ga/(In+Ga+Sn), and tin content is 0.09 as atomic ratio of Sn/(In+Ga+Sn). Film thickness of this transparent conductive film was 12 nm, and surface resistance was 1000Ω/□.

Then, this transparent conductive film was subjected to heat treatment in air at higher temperature 350° C. than crystallization temperature 330° C. of this transparent conductive film. As a result, the transparent conductive film crystallized, however, surface resistance increased to 1200Ω/□. Subsequently, an antireflection film composed of a silicon oxide thin film and a niobium oxide thin film was formed.

After that when a thermal load of 500° C. in air was applied in the formation process of member for position detection of the capacitive touch panel, surface resistance of the above crystallized transparent conductive film increased from 1200Ω/□ to 1300Ω/□. That is, the surface resistance never exceeded 1500Ω/□, therefore there was no problem in the position detection of the capacitive touch panel, and the display of the liquid crystal display apparatus main body.

### Example 4

The capacitive touch panel having a configuration of FIG. 3 was prepared by the similar process as in Example 1, except that target composition was changed to have indium oxide, as a main component, where gallium content is 0.03 as atomic ratio of Ga/(In+Ga+Sn), and tin content is 0.12 as atomic ratio of Sn/(In+Ga+Sn). It was confirmed that the transparent conductive film had the same composition as the target, and a generated phase of the film was amorphous, as an investigation result with X-ray diffraction measurement. Film thickness of this transparent conductive film was 13 nm, and surface resistance was 1000Ω/□.

When a thermal load of 550° C. in air was applied in the in the formation process of member for position detection of the capacitive touch panel, surface resistance of the above transparent conductive film increased from 1000Ω/□ to 1450Ω/□, however, it never exceeded 1500Ω/□, therefore there was no problem in the position detection of the capacitive touch panel, and the display of the liquid crystal display apparatus main body.

### Comparative Example 1

The capacitive touch panel having a configuration of FIG. 3 was prepared by the similar process as in Example 1, except that the target was changed to ITO and as the transparent conductive film, an ITO thin film was formed at a substrate temperature of 300° C. Film thickness of the ITO crystal film was 6 nm, and surface resistance was 1000Ω/□.

When a thermal load of 500° C. in air was applied in the formation process of member for position detection of the capacitive touch panel, surface resistance of the above transparent conductive film increased from 1000Ω/□ to 3000Ω/□. That is, the surface resistance is over 1500Ω/□, and because of such resistance increase of the transparent conductive film composed of the ITO thin film, it was clarified that the signal for position detection of the capacitive touch panel was not transmitted well, and a problem was raised on display of the liquid crystal display apparatus main body.

### Comparative Example 2

The capacitive touch panel having a configuration of FIG. 3 was prepared by the similar process as in Example 1, by using a target similar to that in Example 1, that is, one with a composition having indium oxide, as a main component, where gallium content is 0.05, as atomicity ratio of Ga/(In+Ga+Sn), and tin content is 0.09, as atomicity ratio of Sn/(In+Ga+Sn). It was confirmed that the transparent conductive film has the same composition as that of the target, and a generated phase of the film is amorphous, as an investigation result by X-ray diffraction measurement. Film thickness of this transparent conductive layer was 15 nm, and surface resistance was 1000Ω/□.

When a thermal load of about 700° C. in air, different from Example 1, was applied, in the formation process of member for position detection of the capacitive touch panel, surface resistance of the above transparent conductive film increased from 1000Ω/□ to 5500Ω/□. That is, the surface resistance is over 1500Ω/□, and because of such resistance increase of the transparent conductive film composed of indium oxide as a main component, and containing gallium and tin, it was clarified that the signal for position detection of the capacitive touch panel was not transmitted well, and a problem was raised on display of the liquid crystal display apparatus main body.

1-10. (canceled)

11. A method for producing a capacitive touch panel having a structure where at least a transparent conductive film and a dielectric layer are laminated onto a transparent substrate, and a member for position detection comprising at least the wiring portion for position detection along with the electrodes for position detection is arranged at said substrate frame portion,
characterized in that after forming an amorphous transparent conductive film comprising an oxide having indium oxide as a main component and containing gallium and tin onto said transparent substrate, and before the formation process of the member for position detection, said transparent conductive film is subjected to heat treatment in a temperature range with crystallization temperature, as the lower limit, and with temperature higher by 100° C. than the crystallization temperature, as the upper limit, under atmosphere where oxygen is present or in air.

12. The method for producing the capacitive touch panel according to claim 11, characterized in that said amorphous transparent conductive film is formed onto the transparent substrate at a temperature of equal to or lower than 150° C.

13. The method for producing the capacitive touch panel according to claim 11, characterized in that gallium content of said transparent conductive film is 0.03 to 0.10 as atomic ratio of Ga/(In+Ga+Sn) and tin content is 0.05 to 0.12 as atomic ratio of Sn/(In+Ga+Sn).

14. The method for producing the capacitive touch panel according to claim 11, characterized in that gallium content of said transparent conductive film is 0.05 to 0.08 as atomic ratio of Ga/(In+Ga+Sn) and tin content is 0.07 to 0.10 as atomic ratio of Sn/(In+Ga+Sn).

15. A method for producing a capacitive touch panel having a structure where at least a transparent conductive film and a dielectric layer are laminated onto a transparent substrate, and a member for position detection comprising at least a wiring portion for position detection along with an electrode for position detection is arranged at said substrate frame portion,
characterized in that, the above amorphous or crystalline transparent conductive film is subjected to heat treatment in a temperature range with crystallization temperature, as the lower limit, and with a temperature of 550° C., as the upper limit, under atmosphere where oxygen is present, or in air, in the forming process of the member for position detection.

16. The method for producing the capacitive touch panel according to claim 15, characterized in that gallium content of said transparent conductive film is 0.03 to 0.10 as atomic ratio of Ga/(In+Ga+Sn) and tin content is 0.05 to 0.12 as atomic ratio of Sn/(In+Ga+Sn).

17. The method for producing the capacitive touch panel according to claim 15, characterized in that gallium content of said transparent conductive film is 0.05 to 0.08 as atomic ratio of Ga/(In+Ga+Sn) and tin content is 0.07 to 0.10 as atomic ratio of Sn/(In+Ga+Sn).
